(19) United States
(12) Patent Application Publication
(10) Pub. No.: US 2005/0270593 A1
(43) Pub. Date: Dec. 8, 2005

(54) Scanner

(75) Inventor: Hai-Tao Ma, Wu Chung (CN)

Correspondence Address: RADER FISHMAN & GRAUER PLLC, LION BUILDING, 1233 20TH STREET N.W., SUITE 501, WASHINGTON, DC, 20036, US

(73) Assignee: BenQ Corporation

(21) Appl. No.: 11/132,328

(22) Filed: May 19, 2005

(30) Foreign Application Priority Data
May 19, 2004 (TW) 93114080

(51) Int. Cl. H04N 1/04

(52) U.S. Cl. 358/474

(57) ABSTRACT

A scanner, including a lever and an elastic support element, is provided. The lever includes a first part, a second part and a fulcrum, wherein the first part and the second part are respectively located at opposed sides with respect to the fulcrum, and the second part touches against an image sensor module of the scanner. An elastic force, provided on the first part by the elastic support element, acts on the second part with respect to the fulcrum. When scanning, the elastic force is capable of preventing vertical offset of the image sensor module resulting from mechanical factor or other unexpected factors. Therefore, the image sensor module can retrieve clear images all the time.

### CROSS REFERENCE TO RELATED APPLICATIONS

This application claims priority to Taiwan Patent Application No. 093114080 entitled “SCANNER”, filed on May 19, 2004.

### FIELD OF INVENTION

The present invention generally relates to a scanner, and more particularly, to a scanner with an elastic support element.

### BACKGROUND OF THE INVENTION

A scanner with a contact image sensor (CIS), which is able to transform the image on a medium into digital data for storage or for further process by a computer, is a popular peripheral.

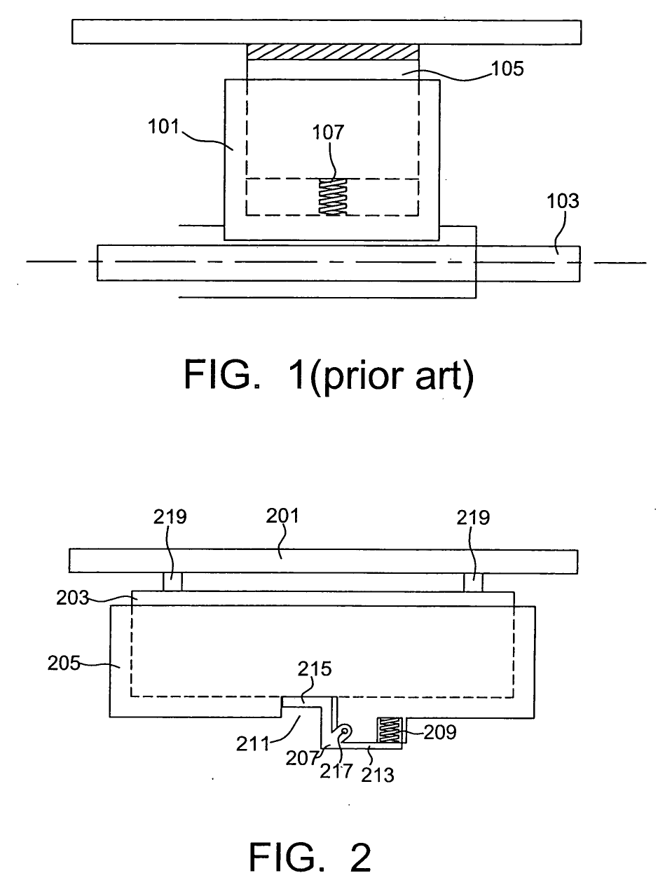

The CIS scanner usually comprises a light source, a pair of focusing lenses, an image sensor and a carriage. However, the typical focusing range of the CIS scanner module is only 0.3 mm, i.e. the allowable difference between focal position and actual position of image is ±0.3 mm for a clear capture of image. Beyond this range, the received image will be blurred and hard to recognize. The focusing range of the CIS scanner module is so small, as illustrated in FIG. 1, that the image sensor 105 may not retrieve clear image as the carriage 101 moves along the guiding shaft 103, due to the non-smoothness of the guiding shaft 103 or unexpected vertical offset resulting from other mechanical factors. To solve this problem, the prior art elastic element 107, being usually a spring, is provided between the carriage 101 and image sensor 105. The elasticity of the prior art elastic element 107 is capable of preventing the vibration during the scanning.

However, since the space between the carriage 101 and the image sensor 105 is limited, the size and the elastic force of the elastic element 107 are limited too, that could reduce the lifespan of the CIS scanner.

### SUMMARY OF THE INVENTION

The present invention provides a scanner which comprises a window glass, an image sensor module, a carriage, a lever and an elastic support element. The papers or the pictures, which are going to be scanned, are put on the window glass. The image sensor module, positioned under the window glass, is configured to capture the image of the papers or the pictures. The carriage is configured to bear the image sensor module. The lever, including a first part and a second part, is rotatably positioned under the carriage, and the second part touches against the image sensor module. The elastic support element, touching against the carriage, provides an elastic force on the first part and then the elastic force acts on the second part, which can keep a constant distance between the image sensor module and the window glass as the image sensor module moves. Consequently, the elastic force is capable of preventing the unexpected vertical offset due to mechanical factor and therefore ensures the image sensor module to retrieve clear image all the time.

Moreover, the carriage has a hole and the lever further has a fulcrum. The first part and the second part of the lever are respectively located at opposed sides with respect to the fulcrum, and the second port of the lever passes through the hole of the carriage for touching against the image sensor module.

The present invention further includes at least a smooth element positioned between the image sensor module and the window glass for reducing the friction force between the image sensor module and the window glass.

The scanner of the present invention further includes a guiding shaft positioned under the carriage for guiding movement of the carriage.

### BRIEF DESCRIPTION OF THE PICTURES

The foregoing aspects and many of the attendant advantages of this invention will become more readily appreciated as the same becomes better understood by reference to the following detailed description, when taken in conjunction with the accompanying pictures, wherein:

FIG. 1 illustrates a profile of a prior art CIS scanner;

FIG. 2 illustrates a side view of the first embodiment in accordance with the present invention;

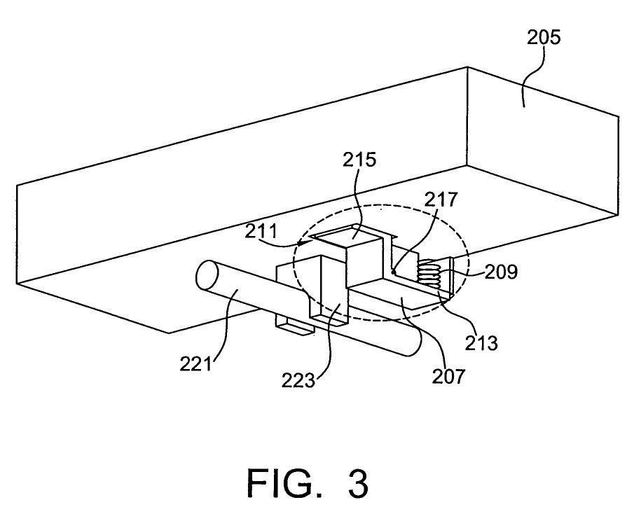

FIG. 3 illustrates a perspective view of the first embodiment in accordance with the present invention;

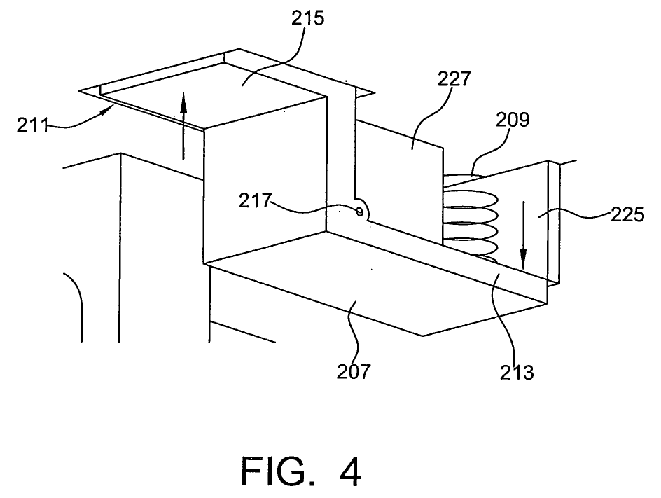

FIG. 4 illustrates a magnification of the dotted line region of FIG. 3;

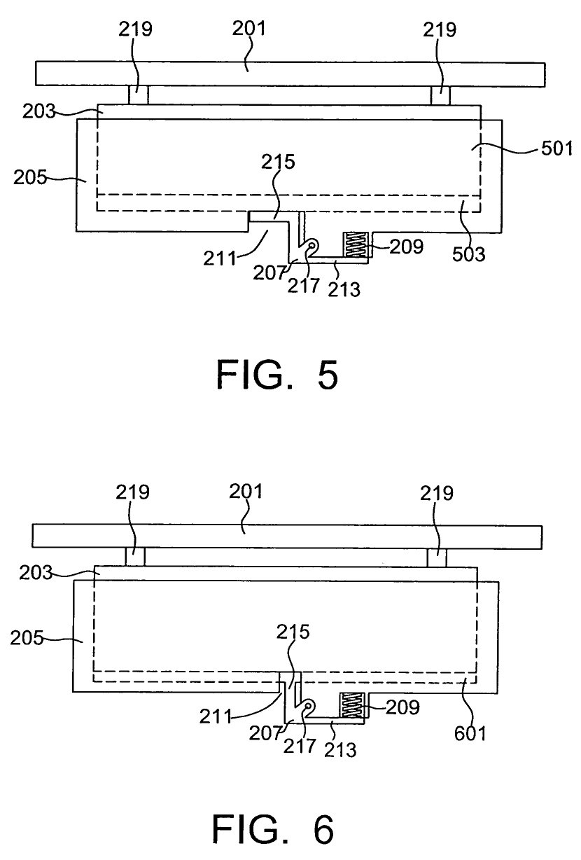

FIG. 5 illustrates a side view of the second embodiment in accordance with the present invention; and

FIG. 6 illustrates a side view of the third embodiment in accordance with the present invention.

### DETAILED DESCRIPTION OF THE INVENTION

With reference to FIGS. 2 and 3, the first embodiment of the present invention includes a window glass 201, a contact image sensor module 203, a carriage 205, a lever 207 and an elastic support element 209. The papers or the pictures, which are going to be scanned, are put on the window glass 201 (referring to FIG. 2). The contact image sensor module 203, positioned under the windows glass 201, includes a contact image sensor (not illustrated) configured to capture the image of the papers or the pictures. The carriage 205, with a hole 211, is configured to bear the contact image sensor module 203. The lever 207 includes a first part 213, a second part 215 and a fulcrum 217, and furthermore the first part 213 and the second part 215 are respectively located at opposed sides with respective to the fulcrum 217, and the second part 215 passes through the hole 211 of the carriage 205 for touching against the lower side of the image sensor module 230. The elastic support element 209, which will go into details as below, touches against the lower side of the carriage 205 and the first part 213.

The embodiment further includes at least two smooth elements 219 (referring to FIG. 2) which are positioned between the two upper sides of the contact image sensor module 203 and the window glass 201. The smooth element 219, made of low friction-coefficient material, is configured to reduce the friction force between the contact image sensor module 203 and window glass 201 when scanning. It should be noted that the present invention is not limited to the number and the shape of the smooth element 219.

The embodiment further includes a guiding shaft 221 (referring to FIG. 3) which is positioned under the carriage 205. The carriage 205 has a bulge 223 with shape allowing coupling with the guiding shaft 221. By the coupling of the bulge 223 with the guiding shaft 221, the carriage 205 can move horizontally while scanning. It should be noted that the present invention is not limited to the shape and structure of the bulge 223.

FIG. 4, which is a magnification of the dotted line region of FIG. 3, illustrates the connection and the interaction between the lever 207 and the elastic support element 209. As shown in FIG. 4, the embodiment further includes a first positioning block 225 and a second positioning block 227 for fixing the position of the elastic support element 209. The elastic support element 209, touching against the lower side of the carriage 205 and the upper side of the first part 213, provides a downward elastic force (as the arrow shows) on the first part 213, and the elastic force generates an upward action force (as the arrow shows) on the second part 215 due to function of the fulcrum 217 of the lever 207. The action force applies on the contact image sensor module 203, which can keep a constant distance between the image sensor module 203 and the window glass 201 as the image sensor module 203 moves. Consequently, the elastic force is capable of preventing the unexpected vertical offset due to mechanical factors and therefore ensures the image sensor module 203 to retrieve clear image all the time.

In this embodiment, the elastic support element 209 is a spring. However, the present invention is not limited to the structure of the elastic support element 209, other structure, such as a spring leaf or a torsion device, also included in the present invention.

FIG. 5 depicts the second embodiment of the present invention. In this embodiment, a contact image sensor 501 and a slab 503, which does not appear in the first embodiment, are included in the contact image sensor module 203. The contact image sensor 501 is configured to capture the image of the papers, and the slab 503, whose area is similar to that of bottom of the contact image sensor 501, is positioned on the lower side of contact image sensor 501 for touching against the second part 215. Because the slab 503, having appropriate hardness, is positioned between the contact image sensor 501 and the second part 215, the slab 503 is capable of preventing the contact image sensor 501 and the second part 215 from touching against each other, to avoid damaging of the contact image sensor 501.

FIG. 6 depicts the third embodiment of the present invention. In the third embodiment, different from the first embodiment, the second part 215 includes a slab 601 whose size is similar with that of the bottom of the contact image sensor module 203. Hence, the slab 601 of the second part 215 provides enough contact area as it touches against the contact image sensor module 230, and therefore the contact image sensor module 230 won't vibrate. As a result, the quality of scanning is assured.

Although the specific embodiments of the present invention have been illustrated and described, it is to be understood that the invention is not limited to those embodiments. One skilled in the art may make various modifications without departing from the scope or spirit of the invention.

1. A scanner, comprising:
a window glass;
an image sensor module positioned under said window glass;
a carriage configured to bear said image sensor module;
a lever comprising a first part and a second part, wherein said lever is rotatably positioned on said carriage and said second part touches against said image sensor module; and
an elastic support element touching against said carriage and said first part;
wherein said elastic support element provides an elastic force on said first part, and said elastic force acts on the second part allowing said image sensor module to keep a constant distance with said window glass as said image sensor module moves.

2. The scanner of claim 1, wherein said carriage has a hole and said lever further has a fulcrum, said first part and said second part are respectively located at opposed sides with respect to said fulcrum, and said second part passing through said hole for touching against said image sensor module.

3. The scanner of claim 1, further comprising a smooth element positioned between said image sensor module and said window glass for reducing a friction force between said image sensor module and said window glass.

4. The scanner of claim 1, further comprising a guiding shaft positioned under said carriage for guiding movement of said carriage.

5. The scanner of claim 1, wherein said image sensor module comprises a contact image sensor and a slab, said slab is positioned under said contact image sensor to touch against said second part.

6. The scanner of claim 1, wherein said second part comprises a slab configured to touch against said image sensor module.

7. The scanner of claim 1, wherein said elastic support element is a spring.

8. The scanner of claim 1, wherein said elastic support element is a spring leaf.

9. A scanner, comprising:
a window glass;
an image sensor module positioned under said window glass;
a carriage configured to bear said image sensor module, said carriage having a hole;
a smooth element positioned between said image sensor module and said window glass for reducing a friction force between said image sensor module and said window glass;
a guiding shaft positioned under said carriage for guiding movement of said carriage;
a lever comprising a first part, a second part and a fulcrum, wherein said lever is rotatably positioned on said carriage, said first part and said second part are respectively located at opposed sides with respect to said fulcrum, and said second part passing through said hole for touching against said image sensor module; and
an elastic support element touching against said carriage and said first part;
wherein said elastic support element provides an elastic force on said first part, and said elastic force acts on the second part with respect to the fulcrum to allowing said image sensor module to keep a constant distance with said window glass as said image sensor module moves.

10. The scanner of claim 9, wherein said image sensor module comprises a contact image sensor and a slab, said slab is positioned under said contact image sensor to touch against said second part.

11. The scanner of claim 9, wherein said second part comprises a slab configured to touch against said image sensor module.

12. The scanner of claim 9, wherein said elastic support element is a spring.

13. The scanner of claim 9, wherein said elastic support element is a spring leaf.
